(19) United States
(12) Patent Application Publication
(10) Pub. No.: US 2021/0218048 A1
(43) Pub. Date: Jul. 15, 2021

(54) ELECTRODE OVERLAYING CONFIGURATION FOR BATTERIES COMPRISING BIPOLAR COMPONENTS

(71) Applicant: GM GLOBAL TECHNOLOGY OPERATIONS LLC, Detroit, MI (US)

(72) Inventors: Fang DAI, Troy, MI (US); Hongliang WANG, Sterling Heights, MI (US); Mahmoud ABD ELHAMID, Troy, MI (US); Shuru CHEN, Troy, MI (US); Mei CAI, Bloomfield Hills, MI (US)

(73) Assignee: GM GLOBAL TECHNOLOGY OPERATIONS LLC, Detroit, MI (US)

(21) Appl. No.: 16/743,699

(22) Filed: Jan. 15, 2020

(51) Int. Cl. H01M 10/04; H01M 10/0525; H01M 4/134; H01M 4/131; H01M 4/136; H01M 4/133

(52) U.S. Cl. CPC H01M 10/0418; H01M 10/0525; H01M 4/134; H01M 2004/029; H01M 4/136; H01M 4/133; H01M 4/131

(57) ABSTRACT

A battery that cycles lithium ions includes at least one first monopolar electrode having a first polarity and having a first tab and at least one second monopolar electrode having a second polarity opposite to the first polarity and a second tab. The first tab and the second tab are in direct electrical communication with an external circuit. At least one bipolar electrode is disposed between and electrically insulated from the first monopolar electrode and the second monopolar electrode, wherein a first side of the bipolar electrode has the first polarity and a second side of the bipolar electrode has the second polarity. The battery thus comprises at least one first unit cell connected in parallel and at least one second unit cell connected in series.

### INTRODUCTION

This section provides background information related to the present disclosure which is not necessarily prior art.

The present disclosure relates to hybrid lithium-ion electrochemical battery cells having a combined output of relatively high voltage and high current and capable of easy assembly and electrode overlaying. The lithium-ion battery may include at least one first monopolar electrode having a first polarity and at least one second monopolar electrode having a second polarity that are respectively in electrical communication with an external circuit. The lithium-ion battery also includes at least one bipolar electrode disposed between and electrically insulated from the first monopolar electrode and the second monopolar electrode to provide a lithium-ion battery with at least one unit cell having a parallel electrical connection and at least one unit cell having a series electrical connection.

High-energy density electrochemical cells, such as lithium-ion batteries or other batteries that cycle lithium ions can be used in a variety of consumer products and vehicles, such as hybrid or electric vehicles. Typical batteries that cycle lithium ions comprise at least one positive electrode or cathode, at least one negative electrode or anode, an electrolyte material, and optionally, a separator. A stack of battery cells may be electrically connected in an electrochemical device to increase overall output. Lithium-ion batteries operate by reversibly passing lithium ions between the negative and positive electrodes. An electrolyte layer and optional separator (where the electrolyte is a liquid or gel) are disposed between the negative and positive electrodes. The electrolyte conducts lithium ions and may be in solid or liquid form. Lithium ions move from a cathode (positive electrode) to an anode (negative electrode) during charging of the battery, and in the opposite direction when discharging the battery. Each of the negative and positive electrodes within a stack is connected to a current collector (typically a metal, such as copper foil for the anode and aluminum foil for the cathode). During battery usage, the current collectors associated with the positive and negative electrodes are connected by an external circuit that allows current generated by electrons to pass between the electrodes to compensate for transport of lithium ions.

The potential difference or voltage of a battery cell can be determined by differences in chemical potentials (e.g., Fermi energy levels) between the electrodes. In a conventional battery under normal operating conditions, the potential difference between the electrodes achieves a maximum achievable value when the battery cell is fully charged and a minimum achievable value when the battery cell is fully discharged. Each battery cell will discharge and the minimum achievable value will be obtained when the electrodes are connected to a load performing the desired function (e.g., electric motor) via an external circuit. Each of the negative and positive electrodes in the battery cell is connected to a current collector (typically a metal, such as copper for the anode and aluminum for the cathode). The current collectors associated with the two electrodes are connected by an external circuit that allows current generated by electrons to pass between the electrodes to compensate for transport of lithium ions across the battery cell. For example, during cell discharge, the internal Li⁺ ionic current from the negative electrode to the positive electrode may be compensated by the electronic current flowing through the external circuit from the negative electrode to the positive electrode of the battery cell.

Each unit cell is electrically connected to the external circuit (within a stack of unit cells forming the battery) and the unit cells are typically connected in parallel, so the battery stack has an increased current output, but generally has the same output voltage as a single unit cell. This is especially true in a conventional stack design, where the stack is assembled in a pouch and then filled with an electrolyte that flows into each respective cell. Thus, the electrolyte can migrate between different unit cells within the battery stack. The shared electrolyte can also limit a maximum voltage output. It would be advantageous to maximize combined voltage output and current of the lithium-ion stack having individual lithium-ion battery cells.

Furthermore, the plurality of tabs connected to the associated current collectors/electrodes are joined and can be welded together to form common positive tabs or negative tabs that may then be appropriately capped or sheathed to form a plurality of positive electrical connectors capable of being connected to an external circuit. However, a greater quantity of welded components can introduce vulnerability and potential mechanical weakness in the robustness of the lithium-ion battery stack. Thus, maximizing performance, while minimizing potential points of weakness in the lithium-ion battery stack would be desirable.

### SUMMARY

This section provides a general summary of the disclosure, and is not a comprehensive disclosure of its full scope or all of its features.

The present disclosure relates to a battery that cycles lithium ions. The battery includes at least one first monopolar electrode having a first polarity and a first electroactive material that reversibly cycles lithium ions disposed on two sides of a first current collector in electrical communication with a first tab. The battery also includes at least one second monopolar electrode having a second polarity opposite to the first polarity and including a second electroactive material that reversibly cycles lithium ions and that is distinct from the first electroactive material. The second electroactive material is disposed on two sides of a second current collector in electrical communication with a second tab. The first tab and the second tab are in electrical communication with an external circuit. The battery also includes at least one bipolar electrode disposed between and electrically insulated from the first monopolar electrode and the second monopolar electrode. A first side of the bipolar electrode has the first polarity and includes a third electroactive material that reversibly cycles lithium ions disposed on a third current collector. The bipolar electrode also has a second side with the second polarity that includes a fourth electroactive material that reversibly cycles lithium ions and disposed on a fourth current collector. The third and fourth current collectors are adjacent to one another and free of any tabs or external electrical connectors. The battery thus includes at least one first unit cell connected in parallel and at least one second unit cell connected in series.

In one aspect, the battery further includes a plurality of first monopolar electrodes, a plurality of second monopolar electrodes, and a plurality of bipolar electrodes. The first tabs of each of the plurality of first monopolar electrodes are connected in parallel with one another. Further, the second tabs of each of the plurality of second monopolar electrodes are connected in parallel with one another.

In one aspect, the first electroactive material and the third electroactive material are the same.

In one aspect, the second electroactive material and the fourth electroactive material are the same.

In one aspect, the first electroactive material and the third electroactive material are independently selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), S, S₈, Li₂S₈, Li₂S₆, Li₂S₄, Li₂S₂, Li₂S and combinations thereof.

In one aspect, the second electroactive material and the fourth electroactive material are independently selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In one aspect, the battery further includes a first separator disposed between the at least one bipolar electrode and the first monopolar electrode and a second separator disposed between the at least one bipolar electrode and the second monopolar electrode.

In one aspect, the battery further includes a first electrolyte in fluid communication with the first separator and the first side of the bipolar electrode. The battery also includes a second electrolyte in fluid communication with the second separator and the second side of the bipolar electrode. The first electrolyte and the second electrolyte are isolated from one another.

In one aspect, the battery further includes a first solid-state electrolyte layer disposed between the at least one bipolar electrode and the first monopolar electrode and a second solid-state electrolyte layer disposed between the at least one bipolar electrode and the second monopolar electrode.

In one aspect, a maximum difference in voltage between the first electroactive material and the fourth electroactive material or between the second electroactive material and the third electroactive material is less than or equal to about 2.4V.

The present disclosure also relates to a battery that cycles lithium ions that includes at least one first monopolar electrode having a first polarity and including a first electroactive material that reversibly cycles lithium ions disposed on two sides of a first current collector in electrical communication with a first tab. The battery further includes at least one second monopolar electrode having a second polarity opposite to the first polarity and including a second electroactive material that reversibly cycles lithium ions and that is distinct from the first electroactive material disposed on two sides of a second current collector in electrical communication with a second tab. The first tab and the second tab are in electrical communication with an external circuit. The battery includes a plurality of bipolar electrodes disposed between and electrically insulated from the first monopolar electrode and the second monopolar electrode. Each bipolar electrode of the plurality of bipolar electrodes defines a first side having the first polarity and including a third electroactive material that reversibly cycles lithium ions disposed on a third current collector. Each bipolar electrode also defines a second side having the second polarity and including a fourth electroactive material that reversibly cycles lithium ions and disposed on a fourth current collector. The third and fourth current collectors are adjacent to one another and free of any tabs or external electrical connectors, and the battery includes at least one first unit cell connected in parallel and a plurality of second unit cells connected in series.

In one aspect, the battery further includes a plurality of first monopolar electrodes and a plurality of second monopolar electrodes. The first tabs of each of the plurality of first monopolar electrodes are connected in parallel with one another and the second tabs of each of the plurality of second monopolar electrodes are connected in parallel with one another.

In one aspect, the first electroactive material and the third electroactive material are the same and the second electroactive material and the fourth electroactive material are the same.

In one aspect, the first electroactive material and the third electroactive material are independently selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof.

In one aspect, the second electroactive material and the fourth electroactive material are independently selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In one aspect, the battery further includes a solid-state electrolyte.

In one aspect, the battery further includes a separator disposed between each bipolar electrode of the plurality of bipolar electrodes and an electrolyte that is isolated from adjacent cells defined by the plurality of bipolar electrodes.

In one aspect, the plurality of bipolar electrodes defines a first terminal bipolar electrode at a first end and a second terminal bipolar electrode at a second end. The lithium-ion battery further includes a first separator disposed between the first terminal bipolar electrode and the first monopolar electrode and a second separator disposed between the second terminal bipolar electrode and the second monopolar electrode.

In one aspect, the plurality of bipolar electrodes include at least two bipolar electrodes disposed between the at least one first monopolar electrode and the at least one second monopolar electrode.

In one aspect, a maximum difference in voltage between the first electroactive material and the fourth electroactive material or between the second electroactive material and the third electroactive material is less than or equal to about 2.4V.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a simplified example of a cross-section of a battery for cycling lithium ions including a dual-sided monopolar negative electrode and a dual-sided monopolar positive electrode.

FIGS. 2A-2C. FIG. 2A shows an exploded perspective view of a battery having a stack of components including dual-sided monopolar negative electrodes and dual-sided monopolar positive electrodes. FIG. 2B shows an overhead schematic view of an assembled battery stack in FIG. 2A, where external tabs of the negative electrodes and positive electrodes have been welded together. FIG. 2C shows a representative circuit diagram of the battery stack in FIG. 2A where the battery unit cells are electrically connected in parallel.

FIG. 3 is a schematic illustration of a simplified example of a cross-section of a bipolar electrode for a battery for cycling lithium ions prepared in accordance with certain aspects of the present disclosure.

FIGS. 4A-4B. FIG. 4A shows a schematic illustration of a simplified example of a cross-section of a battery for cycling lithium ions comprising dual-sided monopolar negative electrodes, dual-sided monopolar positive electrodes, and interlayers of bipolar electrodes disposed therebetween prepared in accordance with certain aspects of the present disclosure. FIG. 4B shows a representative circuit diagram of the battery stack in FIG. 4A where the battery unit cells have both electrical connections in parallel and in series.

FIGS. 5A-5B. FIG. 5A shows a schematic illustration of a simplified example of a cross-section of another battery design for cycling lithium ions. The battery includes dual-sided monopolar negative electrodes, dual-sided monopolar positive electrodes, and a plurality of bipolar electrodes disposed as multiple interlayers between each respective dual-sided monopolar negative electrode and dual-sided monopolar positive electrode in accordance with certain aspects of the present disclosure. FIG. 5B shows a representative circuit diagram of the battery stack in FIG. 5A where the battery unit cells have both electrical connections in parallel and in series.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

High-energy density electrochemical cells, such as batteries that cycle lithium ions, can be used in a variety of consumer products and vehicles, such as hybrid or electric vehicles. Typical batteries comprise at least one positive electrode or cathode, at least one negative electrode or anode, an electrolyte material, and optionally, a separator. A stack of lithium-ion battery cells may be electrically connected in an electrochemical device to increase overall output (for example, typically they are connected in parallel to increase current output).

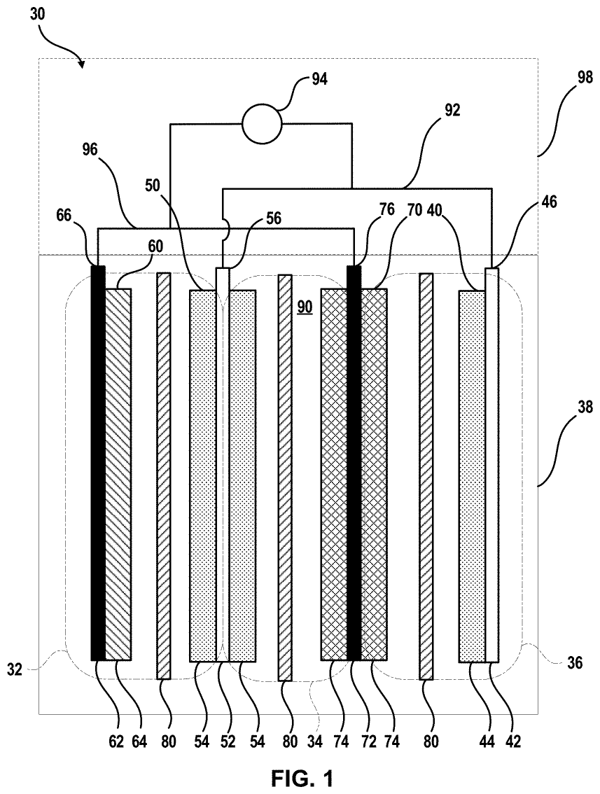

FIG. 1 shows an exemplary schematic illustration of a battery 30 that has three battery unit cells 32, 34, and 36, where the respective components are spaced apart for ease of description (when assembled, the respective components contact one another) and not to scale in dimensions or thicknesses shown. The battery 30 includes at least two positive electrodes, including a terminal positive electrode 40 and a double-sided monopolar positive electrode 50. The battery 30 includes at least two negative electrodes, including a terminal negative electrode 60 and a double-sided monopolar negative electrode 70. Each of the terminal positive electrode 40, monopolar positive electrode 50, monopolar negative electrode 70, and terminal negative electrode 60 define a major surface and are parallel to one another to define a stack of electrode layers.

The terminal positive electrode 40 may include a first positive current collector 42 and at least one first positive electroactive material layer 44. The first positive electroactive material layer(s) 44 may be disposed in electrical communication with the first positive current collector 42 (e.g., disposed at or on one or more parallel surfaces of the first positive current collector 42). The first positive current collector 42 defines or is in contact with a first positive external tab 46 that can be connected (e.g., via welding) to an external circuit, such as a common positive electrical conductor 92. The common positive electrical conductor 92 is in electrical communication with an external load device 94. The load device 94 is also in electrical communication with a common negative electrical conductor 96, which will be described in more detail below. The common positive electrical conductor 92, load device 94, and common negative electrical conductor 96 can form an interruptible external circuit 98.

The double-sided monopolar positive electrode 50 has a second positive current collector 52 and two second positive electroactive material layers 54 disposed on two opposing sides of the second positive current collector 52. The second positive current collector 52 defines or is in contact with a second positive external tab 56 that can be connected (e.g., via welding) to the interruptible external circuit 98 via the common positive electrical conductor 92. As illustrated, the second positive electroactive material layers 54 may be disposed on each opposing side of the second positive current collector 52 to form a bilayer structure for a monopolar electrode having a single polarity.

The one or more first positive electroactive material layers 44 and the two second positive electroactive material layers 54 may each comprise a lithium-based positive electroactive material that is capable of undergoing lithium intercalation and deintercalation, absorption and desorption, alloying and dealloying, or plating and stripping, while functioning as a positive terminal of the battery 30. Generally, the first positive electroactive material layer 44 typically comprises the same lithium-based positive electroactive material as the second positive electroactive material layers 54. As is known in the art, each electroactive layer may be a composite electrode that also includes a polymeric binder and optionally a plurality of electrically conductive particles.

The terminal negative electrode 60 may include a first negative current collector 62 and at least one first negative electroactive material layer 64. The first negative electroactive material layer(s) 64 may be disposed in electrical communication with the first negative current collector 62 (e.g., disposed at or on one or more parallel surfaces of the first negative current collector 62). The first negative current collector 62 defines or is in contact with a first negative external tab 66 that can be connected (e.g., via welding) via a common negative conductor 96 to the interruptible external circuit 98. As noted above, the common negative conductor 96 is in electrical communication with the external load device 94 and the positive conductor 92.

The double-sided monopolar negative electrode 70 has a second negative current collector 72 and two second negative electroactive material layers 74 disposed on two opposing sides of the second negative current collector 72. The second negative current collector 72 defines or is in contact with a second negative external tab 76 that can be connected (e.g., via welding) to an external circuit, such as the common negative electrical conductor 96. As illustrated, the second negative electroactive material layers 74 may be disposed on each opposing side of the second negative current collector 72 to form a bilayer structure for a monopolar electrode having a single polarity.

The first negative electroactive material layer 64 and the second negative electroactive material layers 74 may each comprise a negative electroactive material that is capable of undergoing lithium intercalation and deintercalation, absorption and desorption, alloying and dealloying, or plating and stripping, while functioning as a negative terminal of the battery 30. Generally, the first negative electroactive material layer 64 typically comprises the same negative electroactive material as the second negative electroactive material layers 74. Negative electroactive materials may be metal layers or films or may include a composite that includes negative electroactive material mixed with a polymeric binder and optionally a plurality of electrically conductive particles.

The battery 30 further includes an electrolyte 90. Each of the electrodes 40, 50, 60, 70 may have a porous separator 80 disposed therebetween to provide electrical separation between electrodes of opposite polarities, but to permit ions to flow therethrough. In designs with liquid electrolyte 90, the battery 30 includes a porous separator structure like 80. However, in certain solid electrolyte designs, no separator 80 may be necessary in the electrochemical cell, as the solid electrolyte may serve the role of both electrical insulator and ion conductor. In certain aspects, as shown, the electrodes 40, 50, 60, 70 may be disposed within a single battery housing 38 containing an electrolyte 90.

The first and second positive current collectors 42, 52 and first and second positive external tabs 46, 56 may facilitate the flow of electrons between the positive electrodes 40, 50 and the interruptible external circuit 98. For example, the interruptible external circuit 98 and load device 94 may connect the first terminal positive electrode 40 (through the first positive current collector 42 and first positive external tab 46) and the second monopolar positive electrode 50 (through the second positive current collector 52 and second positive external tab 56).

Likewise, the first and second negative current collectors 62, 72 and first and second negative external tabs 66, 76 may facilitate the flow of electrons between the negative electrodes 60, 70 and the interruptible external circuit 98. For example, the interruptible external circuit 98 and the load device 94 may connect the first terminal negative electrode 60 (through the first negative current collector 62 and first negative external tab 66) and the second monopolar negative electrode 70 (through the second negative current collector 72 and second negative external tab 76).

The load device 94 may be powered by the electric current passing through the external circuit 98 when the battery 30 is discharging. While the electrical load device 94 may be any number of known electrically-powered devices, a few specific examples include an electric motor for an electrified vehicle, a laptop computer, a tablet computer, a cellular phone, and cordless power tools or appliances. The load device 94 may also be an electricity-generating apparatus that charges the battery 30 for purposes of storing electrical energy.

As shown in FIG. 1, a first battery unit cell 32 is defined by the terminal negative electrode 60, one side of the second monopolar positive electrode 50 with the separator 80 disposed therebetween. A second battery unit cell 34 is defined by the other side of the second monopolar positive electrode 50 and one side of the second monopolar negative electrode 70 with the separator 80 disposed therebetween. Finally, a third battery unit cell 36 is defined by the other side of the second monopolar negative electrode 70 and the first terminal positive electrode 40 with the separator 80 disposed therebetween. Each of the three battery unit cells 32, 34, and 36 are thus connected in parallel in the configuration shown in FIG. 1. As discussed above, when unit cells within a stack that forms a battery are connected in parallel with one another, it serves to increase the current output of the battery stack. However, the voltage is limited to differences in chemical potentials (e.g., Fermi energy levels) between the electroactive materials in respective positive and negative electrodes. Further, battery voltage in a stack having multiple unit cells or a stack of unit cells is further limited to a single voltage when a common electrolyte is used that is in potential fluid communication with adjacent unit cells.

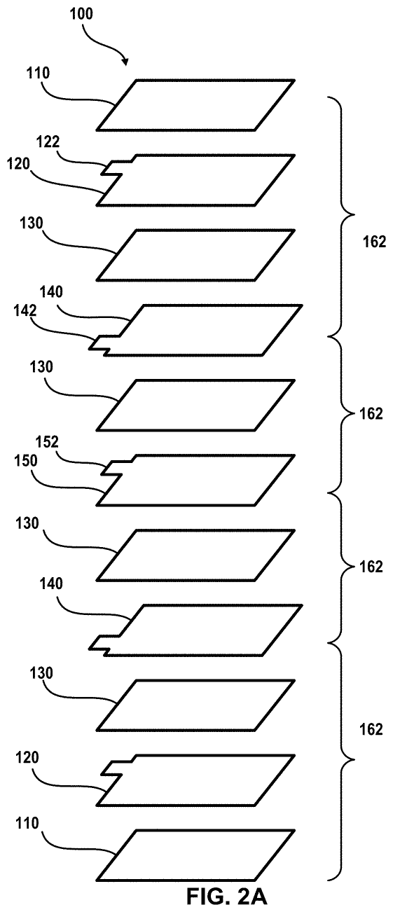

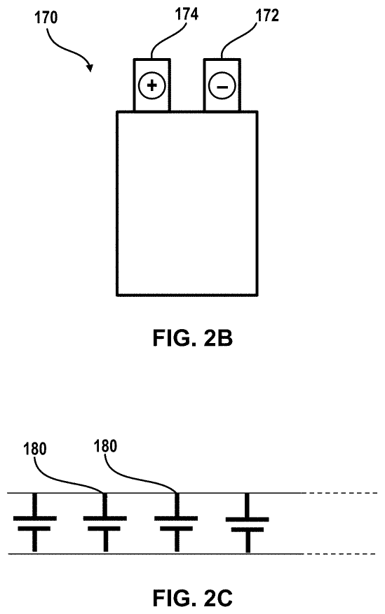

FIG. 2A shows an example battery stack 100 having a plurality of monopolar negative and positive electrodes, like the simplified design shown in FIG. 1. As will be appreciated by those of skill in the art, the battery stack 100 is not limited to the number, configuration, or orientation of components shown and further may comprise a variety of additional components, including seals, gaskets, terminal plates, caps, and the like, by way of non-limiting example. A terminal separator 110 is adjacent to a terminal negative electrode 120. While not shown, the terminal negative electrode 120 has a negative current collector with at least one side coated with a negative electroactive material (like that shown in FIG. 1). As it is a terminal electrode, only one side of the terminal negative electrode 120 may be coated. The negative current collector defines an external conductive tab 122 that extends beyond the dimensions or footprint of terminal negative electrode 120 so that the external conductive tab 122 will protrude from the stack 100 and be available for welding or otherwise electrically connecting it to other conductive components during assembly. A separator 130 is disposed adjacent to the terminal negative electrode 120.

A positive electrode 140 is disposed on an opposite side of the second separator 130 to the terminal negative electrode 120. The positive electrode 140 is a double-sided monopolar design, like double-sided monopolar positive electrode 50 described in FIG. 1. Thus, while not shown in FIG. 2A, the positive electrode 140 has a positive current collector with two opposing sides coated with positive electroactive material layers. The positive current collector defines an external conductive tab 142 that extends beyond the dimensions or footprint of positive electrode 140 so that the external conductive tab 142 protrudes from the stack 100 and is available for welding or otherwise electrically connecting it to other conductive components during assembly. Another separator 130 is disposed adjacent the positive electrode 140 on a side opposite to the terminal negative electrode 120. Thus, two distinct separators 130 are disposed on each side of the positive electrode 140.

A negative electrode 150 is disposed on an opposite side of the separator 130 to the positive electrode 140. The negative electrode 150 is a double-sided monopolar design, like double-sided monopolar negative electrode 70 described in FIG. 1. Thus, while not shown in FIG. 2A, the negative electrode 150 has a negative current collector with two opposing sides coated with negative electroactive material layers. The negative current collector defines an external conductive tab 152 that extends beyond the dimensions or footprint of negative electrode 150 so that the external conductive tab 152 protrudes from the stack 100 and is available for welding or otherwise electrically connecting it to other conductive components during assembly. Another separator 130 is disposed adjacent the negative electrode 150 on a side opposite to the positive electrode 140. Thus, two distinct separators 130 are disposed on each side of the negative electrode 150.

The battery stack 100 includes another positive electrode 140 having a double-sided single polarity design, as described above, adjacent to the separator 130 on a side opposite to the negative electrode 150. Another separator 130 is disposed on an opposite side of the positive electrode 140. Next, another terminal negative electrode 120 is disposed adjacent to the positive electrode 140. Finally, on an opposite side of the terminal negative electrode 120 is terminal separator 110. In this manner, the battery stack 100 has n layers of positive electrodes or cathodes, and n+1 layers of negative electrodes or anodes, and 2n+2 layers of separators. In this design incorporating monopolar double-sided electrodes, multiple battery cell units 162 are defined. As shown in the non-limiting example in FIG. 2A, there are 2 cathodes (n=2), 3 anodes, and 6 separators, that define four distinct unit cells 162 between respective positive and negative electrodes electrically isolated by a separator. In commercial applications, the battery stack 100 may comprise many more components and unit cells, for example, tens or hundreds of unit cells.

As the battery stack 100 is assembled, the various component layers are aligned with one another and contacted/compressed together. As shown in FIG. 2B, the various components, namely the terminal separators 110, terminal negative electrodes 120, positive electrodes 140, separators 130, and negative electrodes 150 are aligned and brought into contact with one another. In this manner, a stack assembly 170 is created, where the plurality of negative external tabs 122 and the plurality of positive external tabs 124 are aligned with one another. During the fabrication process, the negative external tabs 122 can be mechanically and electrically joined together (e.g., via welding) to form a single joined negative tab 172. Similarly, the positive external tabs 152 can be mechanically and electrically joined together (e.g., via welding) to form a single joined positive tab 174. Notably, the alignment process, especially alignment of the external tabs 122 152, can introduce minor amounts of deviation that can cause some mechanical vulnerability in the battery stack 100. Further, each welded component can introduce a mechanical vulnerability into the stack, which may have the possibility of accelerating breakage under certain circumstances.

FIG. 2C reflects a representative circuit of battery stack 100 in FIG. 2A, where four distinct unit cells 162 are each represented by power source symbols 180 electrically connected in parallel with one another. As appreciated by those of skill in the art, additional power sources or battery unit cells may be included in such a stack. The overall effect of having a plurality of unit cells electrically connected in parallel is to increase current density of the stack; however, an overall voltage of the stack remains the same.

In various aspects, the present disclosure provides a new electrode overlaying configuration combining parallel and serial electrical connections between respective electrodes in a battery cell or stack. In various aspects, a bipolar electrode is used between a positive electrode and a negative electrode. The bipolar electrode is in contact with a physically isolated electrolyte from adjacent unit cells in the stack. The battery incorporating this technology thus has an elevated voltage, which can be tailored depending on the number of bipolar electrode interlayers included in the stack. Thus, a combination of internal parallel and serial connections of electrodes is provided. Further, higher current output together with elevated cell voltage is provided. In certain variations, an expensive separator can potentially be removed.

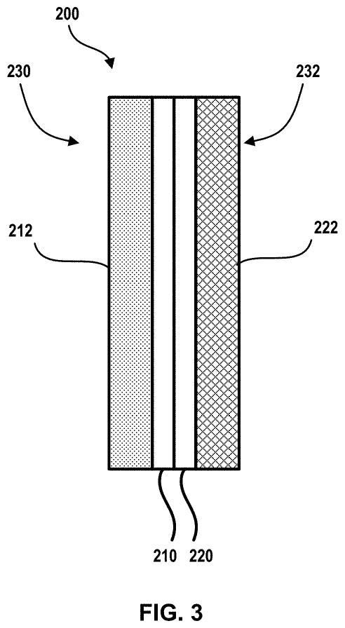

FIG. 3 shows an example of a bipolar electrode 200 that can be used as an interlayer in a battery stack that cycles lithium ions in accordance with certain aspects of the present disclosure. The bipolar electrode 200 includes a positive current collector 210 and a negative current collector 220 that are electrically connected. The positive and negative current collectors 210, 220 may include metal, such as a metal foil, a metal grid or screen, or expanded metal. In certain variations, the positive current collector 210 may be formed from aluminum, stainless steel and/or nickel or any other appropriate electrically conductive materials known to those of skill in the art. The negative current collector 220 may be formed from copper, aluminum, nickel, or any other appropriate electrically conductive material known to those of skill in the art. In various aspects, the positive and negative current collectors 210, 220 may be the same composition (e.g., nickel) or different compositions. Where the positive and negative current collectors 210, 220 are the same composition, it will be appreciated only a single layer of material the current collector may be necessary. Where the positive and negative current collectors 210, 220 are different compositions, it will be appreciated that each current collector is a distinct layer as shown in FIG. 3.

A first side 230 of the bipolar electrode 200 has a first polarity, namely as shown in FIG. 3, a positive polarity. A second side 232 of the bipolar electrode 200 has a second polarity opposite to the first, here a negative polarity. Each of the first side 230 and the second side 232 comprises a layer of a distinct electroactive material. As will be described later below, the electroactive material may be provided as an elemental composition (e.g., a metal foil comprising an electroactive metal material) or as a composite composition, comprising a plurality of electroactive material particles distributed in a polymeric binder, with an optional electrically conductive particle distributed therein. The first side 230 comprises a positive electroactive material 212 that reversibly cycles lithium ions and is disposed on the positive current collector 210. The positive electroactive material 212 is a material that is capable of undergoing lithium intercalation and deintercalation, absorption and desorption, alloying and dealloying, or plating and stripping. The second side 232 comprises a negative electroactive material 222 that reversibly cycles or plates lithium ions. The negative electroactive material 222 is disposed on the negative current collector 220. It should be noted that the bipolar electrode 200 is free of any connection to external tabs. Thus, neither the positive current collector 210 nor the negative current collector 220 defines or is connected to any protruding external tabs. As will be explained further herein, in accordance with certain aspects of the present disclosure, one or more bipolar electrodes 200 are incorporated into a battery stack so that each bipolar electrode is electrically connected in series with adjacent electrodes, but is not directly connected by wiring or terminals to an external circuit (like interruptible circuit 98 in FIG. 1).

Thus, a thickness of a positive electroactive material 212 and/or negative electroactive material 222 in the bipolar electrode 200 may be greater than or equal to about 1 μm to less than or equal to about 1,000 μm (1 mm), optionally greater than or equal to about 10 μm to less than or equal to about 1,000 μm. A thickness of the positive current collector 210 and/or the negative current collector 220 may likewise be greater than or equal to about 2 μm to less than or equal to about 1 mm. Notably, the positive current collector 210 and the negative current collector 220 can be thinner than conventional current collectors in view of the fact that they do not need to provide any external connection (e.g., lack any tab area).

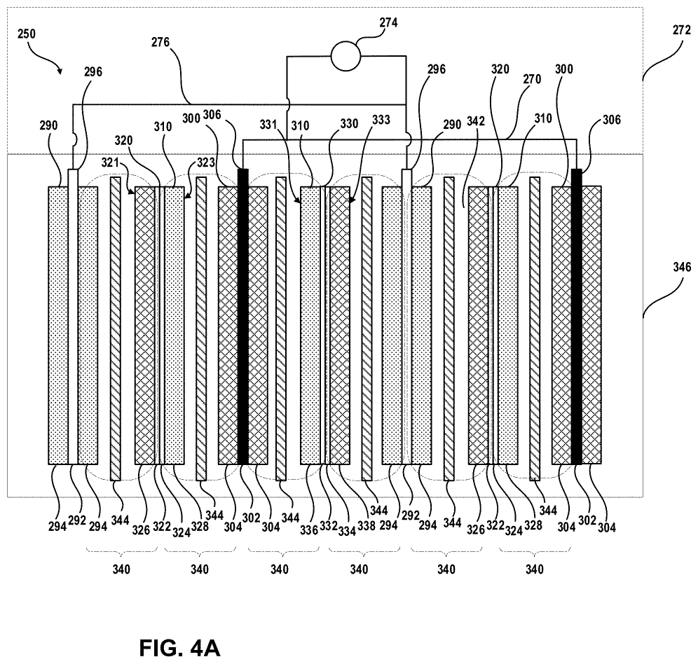

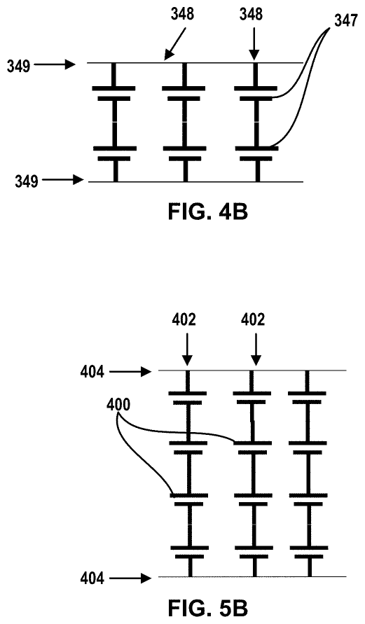

FIG. 4A shows a battery 250 that cycles lithium ions prepared in accordance with certain aspects of the present disclosure that incorporates interlayers of bipolar electrodes between dual-sided monopolar electrodes. As with previous figures, this is a simplified schematic illustration where the respective components are spaced apart for ease of description (when assembled, the respective components contact one another) and are not to scale in dimensions or thicknesses shown. Furthermore, the battery 250 can include a variety of other components that while not depicted here are nonetheless known to those of skill in the art. For instance, the battery 250 may include a casing, gaskets, terminal caps, tabs, battery terminals, and any other conventional components or materials that may be situated within the battery 250, including between or around the negative electrodes, positive electrodes, bipolar plates and/or separators. The battery 250 described herein includes a liquid electrolyte and shows representative concepts of battery operation. However, the battery 250 may also be a solid-state battery that includes a solid-state electrolyte that may have a different design, as known to those of skill in the art.

The battery 250 also includes at least one dual-sided monopolar positive electrode 290 (FIG. 4A includes two dual-sided monopolar positive electrodes). Each dual-sided monopolar positive electrode 290 has a positive current collector 292 and two distinct positive electroactive material layers 294 disposed on two opposing sides of the positive current collector 292. The positive current collector 292 defines or is in contact with a positive external tab 296 that can be connected (e.g., via welding or other connectors) to an interruptible external circuit 272 via a common positive electrical conductor 276.

The interruptible circuit 272 also includes a load device 274 and as will be described below, a common negative electrical conductor 270 that is in direct electrical communication with select negative electrodes in the battery 250 and may be like the examples of the load device 94 described in the context of FIG. 1. The common positive electrical conductor 276, load device 274, and common negative electrical conductor 270 can form the interruptible external circuit 272.

As illustrated, the positive electroactive material layers 294 may be disposed on each opposing side of the positive current collector 292 to form a bilayer structure for a monopolar electrode having a single positive polarity.

The battery 250 also includes at least one dual-sided monopolar negative electrode 300 (FIG. 4A includes two dual-sided monopolar negative electrodes). Each dual-sided monopolar positive electrode 300 has a negative current collector 302 and two negative electroactive material layers 304 disposed on two opposing sides of the negative current collector 302. The negative current collector 302 defines or is in contact with a negative external tab 306 that can be connected (e.g., via welding) to an external circuit, such as the common negative electrical conductor 270. As illustrated, the negative electroactive material layers 304 may be disposed on each opposing side of the negative current collector 302 to form a bilayer structure for a monopolar electrode having a single negative polarity. Notably, in the battery 250 design, the dual-sided monopolar positive electrode 290 and dual-sided monopolar negative electrode 300 are in direct electrical connection with an external circuit (interruptible circuit 272) via the common positive electrical conductor 276 and the common negative electrical conductor 270, respectively. However, as will be described below, certain electrode interlayers in the battery 250 stack do not have external conductor tabs and thus are not directly connected to any external conductor wires or external circuit, but only indirectly in electrical communication with other elements in the stack of the battery 250.

Thus, battery 250 also includes a plurality of bipolar electrodes 310 as interlayers respectively disposed between the dual-sided monopolar positive electrodes 290 and the dual-sided monopolar negative electrodes 300. As shown, a first bipolar electrode 320 has a first orientation of negative and positive polarity sides. There are two first bipolar electrodes 320 in the battery 250 as shown. The first bipolar electrode 320 includes a negative current collector 322 and a positive current collector 324. The negative and positive current collectors 322, 324 may include metal, such as a metal foil, a metal grid or screen, or expanded metal. In certain variations, the positive current collector 324 may be formed from aluminum, stainless steel and/or nickel or any other appropriate electrically conductive materials known to those of skill in the art. The negative current collector 322 may be formed from copper, aluminum, nickel, or any other appropriate electrically conductive material known to those of skill in the art. In various aspects, the negative and positive current collectors 322, 324 may be the same composition (e.g., nickel) or different compositions. Where the negative and positive current collectors 322, 324 are the same composition, it will be appreciated only a single layer of the current collector may be necessary. Where the negative and positive current collectors 322, 324 are different compositions, it will be appreciated that each current collector is a distinct layer as shown in FIG. 4A.

A first side 321 of the bipolar electrode 320 has a first polarity, namely as shown in FIG. 4A, a negative polarity. A second side 323 of the bipolar electrode 320 has a second polarity opposite to the first, here a positive polarity. Each of the first side 321 and the second side 323 comprises a layer of a distinct electroactive material. As will be described later below, the electroactive material may be provided as an elemental composition (e.g., a metal foil comprising an electroactive metal material) or as a composite composition, comprising a plurality of electroactive material particles distributed in a polymeric binder, with an optional electrically conductive particle distributed therein. The first side 321 comprises a negative electroactive material 326 that reversibly cycles or plates lithium ions and is disposed on the negative current collector 322. The second side 323 comprises a positive electroactive material 328 that reversibly cycles or plates lithium ions. The positive electroactive material 328 is disposed on the positive current collector 324. The positive electroactive material 328 is a material that is capable of undergoing lithium intercalation and deintercalation, absorption and desorption, alloying and dealloying, or plating and stripping. It should be noted that the bipolar electrode 320 is free of any tabs or connection to external conductors or circuits. Thus, neither the positive current collector 324 nor the negative current collector 322 defines or is connected to any protruding external tabs or terminals. In accordance with certain aspects of the present disclosure, one or more bipolar electrodes 320 are incorporated into a battery 250 stack so that each bipolar electrode is electrically connected in series with adjacent electrodes, but is not directly connected by wiring or terminals to an external circuit (like interruptible circuit 272).

In the first bipolar electrode 320 having a first orientation of negative and positive polarity sides, the first side 321 with a negative polarity faces the positive electroactive material layer 294 of the dual-sided monopolar positive electrode 290. The second side 323 of the first bipolar electrode 320 with the positive polarity faces the negative electroactive material layer 304 of the dual-sided monopolar negative electrode 300.

A second bipolar electrode 330 is also included in the battery 250 that has a second orientation of negative and positive polarity sides that differs from the first orientation in the first bipolar electrode 320. The second bipolar electrode 330 includes a positive current collector 332 and a negative current collector 334. The positive and negative current collectors 332, 334 may be formed of the same materials as the negative and positive current collectors 322, 324 of the first bipolar electrode 320 and for brevity will not be described again herein. In various aspects, the positive and negative current collectors 332, 334 may be the same composition (e.g., nickel) or different compositions. Where the positive and negative current collectors 332, 334 are the same composition, it will be appreciated only a single layer of material the current collector may be necessary. Where the positive and negative current collectors 332, 334 are different compositions, it will be appreciated that each current collector is a distinct layer as shown in FIG. 4A.

A first side 331 of the second bipolar electrode 330 has a first polarity, namely a positive polarity. A second side 333 of the second bipolar electrode 330 has a second polarity opposite to the first, here a negative polarity. Each of the first side 331 and the second side 333 comprises a layer of a distinct electroactive material. As will be described later below, the electroactive material may be provided as an elemental composition (e.g., a metal foil comprising an electroactive metal material) or as a composite composition, comprising a plurality of electroactive material particles distributed in a polymeric binder, with an optional electrically conductive particle distributed therein. The first side 331 comprises a positive electroactive material 336 that reversibly cycles lithium ions and is disposed on the positive current collector 332. The second side 333 comprises a negative electroactive material 338 that reversibly cycles or plates lithium ions. The negative electroactive material 338 is disposed on the negative current collector 334. The positive electroactive material 336 and the negative electroactive material 338 of the second bipolar electrode 330 may be selected from the same materials and types as the positive electroactive material 328 and the negative electroactive material 326 of the first bipolar electrode 320 and thus will not be described again for brevity.

It should be noted that like the first bipolar electrode 320, the second bipolar electrode 330 is free of any connection to external tabs. Thus, neither the positive current collector 332 nor the negative current collector 334 defines or is connected to any protruding external tabs, terminals, or conductors or wiring. As will be explained further herein, in accordance with certain aspects of the present disclosure, one or more second bipolar electrodes 330 may be incorporated into the battery stack 250, so that each bipolar electrode is electrically connected in series with adjacent electrodes, but is not directly connected by wiring or terminals to an external circuit (like interruptible circuit 272). This provides an advantage of reducing internal resistance within the battery 250. As the entire surface area of the major surfaces of the negative and positive current collectors 322, 332, 324, 334 are active transfer regions for electrons to and from the adjacent electroactive material (rather a small surface region corresponding to a tab), the current distribution is more widespread and internal resistance is reduced.

For the second bipolar electrode 330 having a second orientation of positive and negative polarity sides, the first side 331 with a positive polarity faces the negative electroactive material layer 304 of the dual-sided monopolar negative electrode 300. The second side 333 of the second bipolar electrode 330 with the negative polarity faces the positive electroactive material layer 294 of the dual-sided monopolar positive electrode 290.

In this manner, a plurality of battery unit cells 340 are defined between each electrode of an opposite polarity within battery 250, whether considering the electrodes of opposite polarity to be defined by an electrode in a bipolar interlayer electrode, a monopolar dual-sided electrode, or a terminal electrode.

As will be appreciated by those of skill in the art, each of the first or second bipolar electrodes 320, 330 creates a serial electrical connection with an adjacent electrode of the dual-sided monopolar positive electrode 290 or dual-sided monopolar negative electrode 300. However, the dual-sided monopolar positive electrode 290 and dual-sided monopolar negative electrode 300 are directly connected externally via the common positive conductor 276 and the common negative conductor 270 in a parallel electrical configuration. In this manner, in certain variations, the present disclosure provides a battery that cycles lithium ions that includes a new electrode-overlaying configuration that combines both parallel and serial connection between electrodes in a battery cell. The dimensions or footprint of the battery 250 remains the same. However, the presence of the battery cells/internal units connected in parallel provide higher current output, while the series cells provide elevated cell voltage. FIG. 4B shows a representative circuit diagram of the battery 250 stack in FIG. 4A where the battery unit cells have both electrical connections in parallel and in series.

FIG. 4B reflects a representative circuit of battery 250 stack in FIG. 4A, where the four distinct unit cells 340 are each represented by power source symbols 347. Thus, the interlayers of bipolar electrodes introduce serially electrically connected power sources 347 as shown in each respective columns 348, as well as power sources 347 being electrically connected in parallel with one another as shown at rows 349 corresponding to each monopolar electrode (290 or 300) connected in parallel with the external circuit. As appreciated by those of skill in the art, the battery 250 may include additional components that create additional power sources 347/battery unit cells 340 in such a stack. The overall effect of having a plurality of unit cells electrically connected in parallel is to increase current density of the stack, while select unit cells being configured to be in parallel and electrically connected internally within the stack increases an overall voltage of the stack.

For example, the cell voltage is the voltage between the cathode and anode in a given cell. Voltage=V_{bipolar interlayer cathode}+V_{anode}. Because of the presence of the bipolar electrode interlayer, the voltage can thus be doubled for each unit cell. For common Li—S chemistry, the average cell voltage is 2.1V, so by the design shown in battery 250, a voltage (V) will be 4.2 V (where 2.1V+2.1V=4.2V).

With renewed reference to FIG. 4A, the battery 250 further includes an electrolyte 342. Each of the electrodes 290, 300, 320, 330 may have a porous separator 344 disposed therebetween to provide electrical separation between electrodes of opposite polarities, but to permit ions to flow therethrough. The electrolyte 342 can be liquid, gel or solid phase. For a solid phase electrolyte 342, a separator 344 may not be necessary, as the solid electrolyte may serve the role of both electrical insulator and ion conductor. However, in designs with liquid electrolyte 344, the battery 250 includes a porous separator structure like 344. In certain aspects, the electrodes 290, 300, 320, 330 may be disposed within a battery housing 346. Notably, while not shown, the battery housing 346 may be subdivided into sealed compartments to ensure that the electrolyte 342, especially liquid electrolyte, is isolated and does not pass between adjacent battery unit cells 340. Thus, each unit cell may be sealed (e.g., hermetically sealed) to ensure that the liquid or gel electrolyte does not pass to adjacent battery unit cells 340, but may have external tabs or electrical connectors. Thus, in certain aspects, each battery unit cell 340 may comprise a first electrolyte in fluid communication with its respective separator, one side of the bipolar electrode, and one side of a first monopolar electrode. Further, an adjacent battery unit cell 340 may comprise a second electrolyte in fluid communication with its respective separator and an opposite side of the bipolar electrode and one side of a distinct second monopolar electrode, such that the first electrolyte and the second electrolyte are isolated from one another. The first electrolyte and the second electrolyte may be the same composition or distinct compositions.

In embodiments where the electrolyte 342 is a solid-state electrolyte, such subdivisions or isolated compartments to contain respective battery unit cells 340 is not necessary. For example, while not shown, a first solid-state electrolyte layer may be disposed between the at least one bipolar electrode and the first monopolar electrode (in the locations where the separator 344 is shown in FIG. 4A) and a second solid-state electrolyte layer may be disposed between the at least one bipolar electrode and the second monopolar electrode (again, in the locations where the separator 344 is shown in FIG. 4A).

With respect to the compositions of the various electroactive materials, the positive and negative electroactive materials (negative electroactive material layer 364, positive electroactive material layer 374 positive electroactive material layers 294, negative electroactive material layers 304) of the monopolar electrodes (dual-sided monopolar positive electrode 290 and dual-sided monopolar negative electrode 300) may be selected to be the same as or different from the positive and negative electrode active materials (negative electroactive material 326, positive electroactive material 328, positive electroactive material 336, negative electroactive material 338) of the bipolar electrodes (first bipolar electrode 320, and second bipolar electrode 330). Thus, the discussion of positive and negative electroactive material compositions may be employed for any of these active materials in the various electrodes. Generally, speaking the present teachings are particularly useful in incorporating active materials with low voltage chemistries that may otherwise be advantageous, as batteries incorporating such active materials have elevated cell voltages compensating for the otherwise low voltage of each individual cell. For example, lithium-sulfur batteries have a relatively low theoretical voltage difference between positive and negative electrodes of about 2.1V. In certain aspects, LiNiₓMn_{y}Co_{1-x-y}O₂ (where 0≤x≤1 and 0≤y≤1, nickel manganese cobalt (NMC))-LTO (lithium titanate) batteries have a maximum difference in voltage between a first electroactive material having a first polarity in a terminal electrode or monopolar electrode and an electroactive material having a second opposite polarity in the bipolar electrode is less than or equal to about 2.4 V.

In various aspects, the positive electroactive material for a positive electrode may be one of a layered-oxide cathode, a spinel cathode, a polyanion cathode, a lithium-sulfur cathode. For example, layered-oxide cathodes (e.g., rock salt layered oxides) comprise one or more lithium-based positive electroactive materials selected from LiNiₓMn_{y}Co_{1-x-y}O₂ (where 0≤x≤1 and 0≤y≤1, referred to generally as “NMC”)), NMC111, NMC523, NMC622, NMC 721, NMC811, LiNiₓMn₁₋ₓO₂ (where 0≤x≤1), Li₁₊ₓMO₂ (where M is one or more of Mn, Ni, Co, and Al and 0≤x≤1) (for example LiCoO₂ (LCO), LiNiO₂, LiMnO₂, LiNi_{0.5}Mn_{0.5}O₂, NCA, and the like). Spinel cathodes comprise one or more lithium-based positive electroactive materials selected from lithium manganese oxide (Li₍₁₊ₓ₎Mn₍₂₋ₓ₎O₄), where x is typically less than 0.15, including LiMn₂O₄ (LMO) and lithium manganese nickel oxide LiMn_{1.5}Ni_{0.5}O₄ (LMNO). Olivine type cathodes comprise one or more lithium-based positive electroactive material such as LiV₂(PO₄)₃, LiFePO₄, LiCoPO₄, and LiMnPO₄. Favorite type cathodes comprise, for example, LiVPO₄F. Borate type cathodes comprise, for example, one or more of LiFeBO₃, LiCoBO₃, and LiMnBO₃. Silicate type cathodes comprise, for example, Li₂FeSiO₄, Li₂MnSiO₄, and LiMnSiO₄F. Lithium-sulfur based cathodes include sulfur-based electroactive materials, for example, elemental sulfur (S) and/or Li₂Sx where 1≤x≤8, for example one or more of S, S₈, Li₂S₈, Li₂S₆, Li₂S₄, Li₂S₂, and Li₂S. In still further variations, the positive electrode may comprise one or more other positive electroactive materials, such as one or more of dilithium (2,5-dilithiooxy)terephthalate and polyimide. In various aspects, the positive electroactive material may be optionally coated (for example by LiNbO₃ and/or Al₂O₃) and/or may be doped (for example by one or more of magnesium (Mg), aluminum (Al), and manganese (Mn)).

In other variations, the positive electroactive material may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used.

The positive electroactive material in the positive electrode may be optionally intermingled with or coated with one or more electrically conductive materials that provide an electron conductive path. Where the positive electrode is in a composite form, at least one polymeric binder material can be introduced as a matrix that improves the structural integrity of the positive electrode. For example, the positive electroactive material in the positive electrode may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, conductive metal particles may include nickel, gold, silver, copper, aluminum, or other electrically conductive metal particles/powder, or a conductive polymer. Examples of a conductive polymer include polyaniline, polythiophene, polyacetylene, polypyrrole, and the like. Carbon-based conductive materials may include, for example, particles of carbon black, graphite, acetylene black (such as KETCHEN™ black or DENKA™ black), carbon fibers and nanotubes, graphene, and the like.

The positive electrode in a composite form may include greater than or equal to about 50 wt. % to less than or equal to about 99 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more polymeric binders.

In certain variations, one or more of the positive electrodes in the battery may include an electroactive material and thus, may comprise an active material, such as carbon-containing compounds, such as disordered carbons and graphitic carbons/graphite, porous carbon materials that include activated carbons (AC), carbon xerogels, carbon nanotubes (CNTs), mesoporous carbons, templated carbons, carbide-derived carbons (CDCs), graphene, porous carbon spheres, and heteroatom-doped carbon materials. Other active materials may also be included, such as noble metal oxides, e.g., RuO₂, transition metal oxides or hydroxides, such as MnO₂, NiO, Co₃O₄, Co(OH)₂, Ni(OH)₂, and the like. Conducting polymers, such as polyaniline (PANT), polythiophene (PTh), polyacetylene, polypyrrole (PPy), and the like could be used as other electroactive materials. In yet other aspects, the electroactive material may be silicon, silicon-containing alloys, tin-containing alloys, a lithium titanate compound selected from the group consisting of: Li₄₊ₓTi₅O₁₂, where 0≤x≤3, including lithium titanate (Li₄Ti₅O₁₂) (LTO), Li₄₋ₓ^{a}_{/3}Ti₅₋ₓ^{a}_{/3}Crₓ^{a} O₁₂, where 0≤x^{a}≤1, Li₄Ti₅₋ₓ^{b}Scₓ^{b}O₁₂, where 0≤x^{b}≤1, Li₄₋ₓ^{c}Znₓ^{c}Ti₅O₁₂, where 0≤x^{c}≤1, Li₄TiNb₂O₇, and combinations thereof.

In certain variations, an electroactive material may be selected from the group consisting of: activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, such as RuO₂, transition metals, hydroxides of transition metals, MnO₂, NiO, Co₃O₄, Co(OH)₂, Ni(OH)₂, polyaniline (PANT), polythiophene (PTh), polyacetylene, polypyrrole (PPy), and the like.

Any of the positive current collectors may be formed from aluminum, nickel, or any other appropriate electrically conductive material known to those of skill in the art. As noted above, the positive current collector may be coated on one or more sides with layers of positive electroactive materials.

In various aspects, the negative electroactive material for a negative electrode may be a lithium host material that is capable of functioning as a negative terminal of a battery that cycles lithium ions. For example, the negative electrode may comprise a negative electroactive material including carbon-containing compounds, like graphite, silicon oxide activated carbon (AC), hard carbon (HC), soft carbon (SC), graphite, graphene, carbon nanotubes, and the like. Graphite is a high-energy capacity negative electroactive material. Commercial forms of graphite and other graphene materials may be used as electroactive materials. Other materials include, for example, silicon (Si), tin (Sn), and lithium (Li), including lithium-silicon and silicon containing binary and ternary alloys and/or tin-containing alloys, such as Si—Sn, SiSnFe, SiSnAl, SiFeCo, SnO₂, and the like. Titanium dioxide (TiO₂) is also a suitable negative electroactive material. In certain variations, the negative electroactive material may be a lithium titanate compound selected from the group consisting of: Li₄₊ₓTi₅O₁₂, where 0≤x≤3, Li_{4-xa/3}Ti_{5-2xa/3}CrₓₐO₁₂, where 0≤xa≤1, Li₄Ti_{5-xb}Sc_{xb}O₁₂, where 0≤xb≤1, Li_{4-xc}Zn_{xc}Ti₅O₁₂, where 0≤xc≤1, Li₄TiNb₂O₇, and combinations thereof. In certain variations, the electroactive material comprises Li₄₊ₓTi₅O₁₂, where 0≤x≤3, including lithium titanate (Li₄Ti₅O₁₂) (LTO). Lithium may be provided as an elemental metal or in alloyed form. Lithium metal can form a lithium metal anode (LMA) useful in various batteries, including in a lithium-sulfur battery. Other suitable negative electroactive materials include ferrous sulfide (FeS), vanadium pentoxide (V₂O₅). titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

In certain aspects, a negative electrode may have a negative electroactive material selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, the negative electroactive material in the negative electrode may be optionally intermingled with one or more electrically conductive materials that provide an electron conductive path and/or at least one polymeric binder material when in the form of a composite electrode to improve the structural integrity of the negative electrode. For example, the negative electroactive material in the negative electrode may be optionally intermingled with the polymeric binders or electrically conductive materials described above in the context of the positive electrodes.

The negative electrode may include greater than or equal to about 50 wt. % to less than or equal to about 100 wt. %, and in certain aspects, optionally greater than or equal to about 50 wt. % to less than or equal to about 99 wt. %, of the negative electroactive material (e.g., lithium particles or a lithium foil); greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. % of one or more polymeric binders.

Each of the negative electrode current collectors, negative electrodes, separators, solid state-electrolytes, positive electrodes, and positive electrode current collectors are prepared as relatively thin layers (for example, from several microns to a fraction of a millimeter or less in thickness). Thus, a thickness of suitable positive or negative electrodes, whether used on a terminal electrode, monopolar electrode, or bipolar electrode may be greater than or equal to about 1 μm to less than or equal to about 1,000 μm (1 mm), optionally greater than or equal to about 10 μm to less than or equal to about 1,000 μm.

In various aspects, the battery may include greater than or equal to about 1 wt. % to less than or equal to about 25 wt. %, and in certain aspects, optionally greater than or equal to about 3 wt. % to less than or equal to about 20 wt. %, of the electrolyte. Any appropriate electrolyte, whether in solid, liquid, or gel form, capable of conducting lithium ions between the respective electrodes (e.g., dual-sided monopolar positive electrode 290, dual-sided monopolar negative electrode 300, first bipolar electrode 320, and second bipolar electrode 330) may be used in the battery. As noted above, the electrolyte is each unit cell (one electrode of positive polarity, a separator, and one electrode of negative polarity) is isolated from electrolyte in adjacent cells.

The electrolyte may be a non-aqueous liquid electrolyte solution that includes a lithium salt dissolved in an organic solvent or a mixture of organic solvents. Numerous conventional non-aqueous liquid electrolyte solutions may be employed in the battery.

Appropriate lithium salts generally include inert anions. A non-limiting list of lithium salts that may be dissolved in an organic solvent or a mixture of organic solvents to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), and combinations thereof. In certain variations, the lithium salt is selected from lithium hexafluorophosphate (LiPF₆), lithium bis(trifluoromethanesulfonimide) (LiTF(LiN(CF₃SO₂)₂), lithium fluorosulfonylimide (LiN(FSO₂)₂) (LiFSI), and combinations thereof.

These and other similar lithium salts may be dissolved in a variety of organic solvents, including but not limited to various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran), 1,3-dioxolane (DOL)), sulfur compounds (e.g., sulfolane), and combinations thereof. In various aspects, the electrolyte may include greater than or equal to 1M to less than or equal to about 2M concentration of the one or more lithium salts. In certain variations, for example when the electrolyte has a lithium concentration greater than about 2M or ionic liquids, the electrolyte may include one or more diluters, such as fluoroethylene carbonate (FEC) and/or hydrofluoroether (HFE). A liquid electrolyte may be imbibed into pores of an electrode material in certain variations.

In various aspects, the electrolyte may be a solid-state electrolyte including one or more solid-state electrolyte particles that may comprise one or more polymer-based particles, oxide-based particles, sulfide-based particles, halide-based particles, borate-based particles, nitride-based particles, and hydride-based particles. Such a solid-state electrolyte may be disposed in a plurality of layers so as to define a three-dimensional structure. In various aspects, the polymer-based particles may be intermingled with a lithium salt to act as a solid solvent. Notably, such a solid electrolyte may be included in an electrode, for example, by mixing it with electroactive particles and/or electrically conductive particles when forming the electrode. In this manner, a binder-free electrode is contemplated.

In certain variations, the polymer-based particles forming the solid-state electrolyte may comprise one or more of polymer materials selected from the group consisting of: polyethylene glycol, poly(p-phenylene oxide) (PPO), poly(methyl methacrylate) (PMMA), polyacrylonitrile (PAN), polyvinylidene fluoride (PVDF), poly(vinylidene fluoride-co-hexafluoropropylene (PVDF-HFP), polyvinyl chloride (PVC), and combinations thereof. In one variation, the one or more polymer materials may have an ionic conductivity equal to about 10⁻⁴ S/cm.

In various aspects, the oxide-based particles may comprise one or more garnet ceramics, LISICON-type oxides, NASICON-type oxides, and Perovskite type ceramics. For example, the one or more garnet ceramics may be selected from the group consisting of: Li_{6.5}La₃Zr_{1.75}Te_{0.25}O₁₂, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The one or more LISICON-type oxides may be selected from the group consisting of: Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The one or more NASICON-type oxides may be defined by LiMM′(PO₄)₃, where M and M′ are independently selected from Al, Ge, Ti, Sn, Hf, Zr, and La. For example, in certain variations, the one or more NASICON-type oxides may be selected from the group consisting of: Li₁₊ₓAlₓGe₂₋ₓ(PO₄)₃ (LAGP) (where 0≤x≤2), Li₁₊ₓAlₓTi₂₋ₓ(PO₄)₃ (LATP) (where 0≤x≤2), Li₁₋ₓYₓZr₂₋ₓ(PO₄)₃ (LYZP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The one or more Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof. In one variation, the one or more oxide-based materials may have an ionic conductivity greater than or equal to about 10⁻⁵ S/cm to less than or equal to about 10⁻³ S/cm.

In various aspects, the sulfide-based particles may include one or more sulfide-based materials selected from the group consisting of: Li₂S—P₂S₅, Li₂S—P₂S₅-MSₓ (where M is Si, Ge, and Sn and 0≤x≤2), Li_{3.4}Si_{0.4}P_{0.6}S₄, Li₁₀GeP₂S_{11.7}O_{0.3}, Li_{9.6}P₃S₁₂, Li₇P₃S₁₁, Li₉P₃S₉O₃, Li_{10.35}Si_{1.35}P_{1.65}S₁₂, L_{19.81}Sn_{0.81}P_{2.19}S₁₂, Li₁₀(Si_{0.5}Ge_{0.5})P₂S₁₂, Li(Ge_{0.5}Sn_{0.5})P₂S₁₂, Li(Si_{0.5}Sn_{0.5})PₛS₁₂, Li₁₀GeP₂S₁₂ (LGPS), Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5≤x≤0.7), and combinations thereof. In one variation, the one or more sulfide-based materials may have an ionic conductivity greater than or equal to about 10⁻⁷ S/cm to less than or equal to about 10⁻² S/cm.

In various aspects, the halide-based particles may include one or more halide-based materials selected from the group consisting of: Li₂CdCl₄, Li₂MgCl₄, Li₂CdI₄, Li₂ZnI₄, Li₃OCl, LiI, Li₅ZnI₄, Li₃OCl₁₋ₓBrₓ (where 0<x<1), and combinations thereof. In one variation, the one or more halide-based materials may have an ionic conductivity greater than or equal to about 10⁻⁸ S/cm to less than or equal to about 10⁻⁵ S/cm.

In various aspects, the borate-based particles may include one or more borate-based materials selected from the group consisting of: Li₂B₄O₇, Li₂O—(B₂O₃)—(P₂O₅), and combinations thereof. In one variation, the one or more borate-based materials may have an ionic conductivity greater than or equal to about 10⁻⁷ S/cm to less than or equal to about 10⁻⁶ S/cm.

In various aspects, the nitride-based particles may include one or more nitride-based materials selected from the group consisting of: Li₃N, Li₇PN₄, LiSi₂N₃, LiPON, and combinations thereof. In one variation, the one or more nitride-based materials may have an ionic conductivity greater than or equal to about 10⁻⁹ S/cm to less than or equal to about 10⁻³ S/cm.

In various aspects, the hydride-based particles may include one or more hydride-based materials selected from the group consisting of: Li₃AlH₆, LiBH₄, LiBH₄—LiX (where X is one of Cl, Br, and I), LiNH₂, Li₂NH, LiBH₄—LiNH₂, and combinations thereof. In one variation, the one or more hydride-based materials may have an ionic conductivity greater than or equal to about 10⁻⁷ S/cm to less than or equal to about 10⁻⁴ S/cm.

In still further variations, the electrolyte may be a quasi-solid electrolyte comprising a hybrid of the above detailed non-aqueous liquid electrolyte solution and solid-state electrolyte systems—for example including one or more ionic liquids and one or more metal oxide particles, such as aluminum oxide (Al₂O₃) and/or silicon dioxide (SiO₂).

When the electrolyte is a liquid, a porous separator may include, in instances, a microporous polymeric separator including a polyolefin (including those made from a homopolymer (derived from a single monomer constituent) or a heteropolymer (derived from more than one monomer constituent)), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2320 (a trilayer polypropylene/polyethylene/polypropylene separator) available from Celgard LLC.

When the porous separator is a microporous polymeric separator, it may be a single layer or a multi-layer laminate. For example, in one embodiment, a single layer of the polyolefin may form the entire microporous polymer separator. In other aspects, the separator may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator. The microporous polymer separator may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, and/or combinations thereof.

Furthermore, the porous separator may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator are contemplated.

In certain aspects, the positive or negative electrode, including those forming the bipolar electrodes, can be coated with ceramic coating that is configured to act as a separator. Thus, the above-described materials may also be applied to the electrodes themselves.

An electrode in a composite form may be made by mixing the electrode active material into a slurry with a polymeric binder compound, a non-aqueous solvent, optionally a plasticizer, and optionally if necessary, electrically conductive particles. The slurry can be mixed or agitated, and then thinly applied to a substrate via a doctor blade. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperatures to form self-supporting films. If the substrate is removable, it is then removed from the electrode film that is then further laminated to a current collector. With either type of substrate, it may be necessary to extract or remove the remaining plasticizer prior to incorporation into the battery cell.

Alternatively, active materials, such as lithium metal may be deposited, for example, via a coating formation process, such as in atomic layer deposition (ALD), or physical vapor deposition, or chemical vapor infiltration or joined as a preformed film with a current collector.

Notably, when forming a bipolar electrode having two distinct active materials on opposite sides, a first electrode can be applied to a current collector (either a single layer of a single material or a bilayer/bimetal current collector) by the above described methods followed sequentially by applying a second electrode to a second side of the current collector. In other aspects, the first electrode precursor can be applied, followed by applying the second electrode precursor, and then both can be treated together by applying via heat and/or radiation, etc. The bipolar electrode can then be consolidated. In another variation, a bipolar electrode may be formed by creating both sides separately and then joining the current collectors together. Thus, a first electrode can be applied to a first current collector and processed for solidification, a second electrode applied to a second current collector and processed for solidification and then the first and second current collectors can be mechanically joined together (e.g., via adhesive, welding, or mechanical fasteners).

Components may thus be assembled in a laminated cell structure by disposing electrolyte/separator between each anode and cathode of monopolar or bipolar electrodes. Generally, an electrochemical cell can refer to a unit that can be connected to other units, as described above in the context of FIGS. 1 and 4A. A plurality of electrically connected cells, for example, those that are stacked together, may be considered to be a module. A pack generally refers to a plurality of operatively connected modules, which may be electrically connected in various combinations of series or parallel connections. The battery module may thus be encased in a pouch structure, a housing, or located with a plurality of other battery modules to form a battery pack. In certain aspects, the battery module may be part of a prismatic hybrid cell battery.

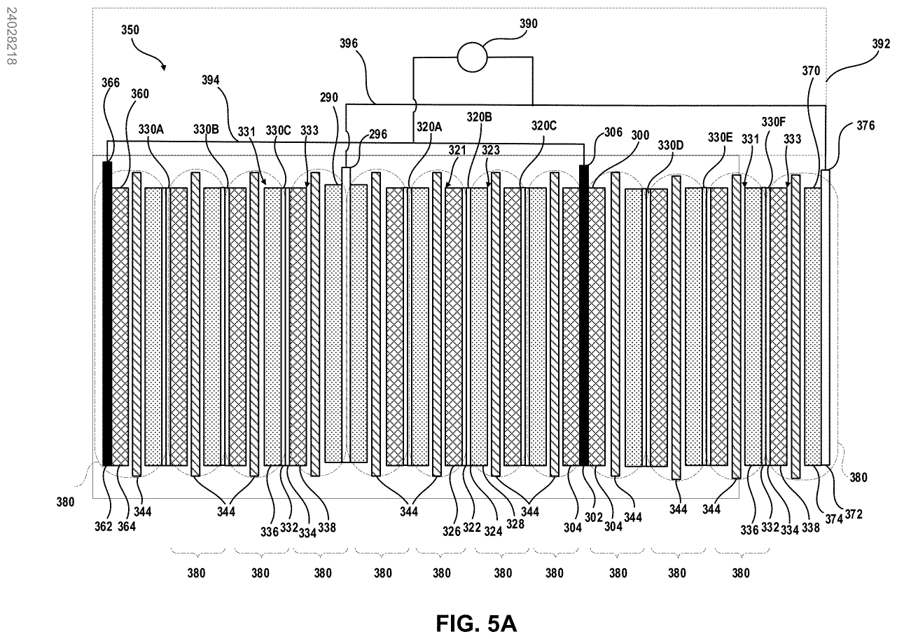

FIG. 5A shows a schematic illustration of an alternative battery 350 that cycles lithium ions prepared in accordance with certain aspects of the present disclosure that incorporates interlayers of multiple bipolar electrodes between respective dual-sided monopolar electrodes to further enhance voltage of the battery.

As with previous figures, this is a simplified schematic illustration where the respective components are spaced apart for ease of description (when assembled, the respective components contact one another) and are not to scale in dimensions or thicknesses shown. Furthermore, the battery 350 can include a variety of other components that while not depicted here are nonetheless known to those of skill in the art. For instance, the battery 350 may include a casing, gaskets, terminal caps, tabs, battery terminals, and any other conventional components or materials that may be situated within the battery 350, including between or around the negative electrodes, positive electrodes, bipolar plates and/or separators. The battery 350 described herein includes a liquid electrolyte and shows representative concepts of battery operation. However, the battery 350 may also be a solid-state battery that includes a solid-state electrolyte that may have a different design, as known to those of skill in the art.

The battery 250 in FIG. 4A shares many of the same components as battery 350 in FIG. 5A arranged in a different configuration. Therefore, to the extent that the components in FIG. 5A are the same (e.g., in function and composition) as those described in FIG. 4A, for brevity, unless otherwise addressed, they will not be discussed again herein.

In battery 350, a plurality of bipolar electrodes are disposed between terminal electrodes and/or monopolar electrodes. Battery 350 includes a terminal negative electrode 360. The terminal negative electrode 360 may include a negative current collector 362 and at least one negative electroactive material layer 364 (as shown, a single layer of the negative electroactive material). The negative electroactive material layer(s) 364 is in electrical communication with the negative current collector 362 (e.g., disposed at or on a major active surface of the negative current collector 362). The negative current collector 362 defines or is in contact with a first negative external tab 366 that can be connected (e.g., via welding) to common negative electrical conductor 394 that is in electrical communication with an interruptible external circuit 392.

The interruptible circuit 392 also includes a load device 390 and as will be described below, a common positive electrical conductor 396 that is in direct electrical communication with select positive electrodes in the battery 350 and may be like the examples of the load device 94 described in the context of FIG. 1. The common positive electrical conductor 396, load device 390, and common negative electrical conductor 394 can form the interruptible external circuit 392.

The battery 350 also includes a terminal positive electrode 370. The terminal positive electrode 370 includes a positive current collector 372 and at least one positive electroactive material layer 374. The positive electroactive material layer(s) 374 may be disposed in electrical communication with the positive current collector 372 (e.g., disposed at or on one or more major surfaces of the positive current collector 372). The positive current collector 372 defines or is in contact with a first positive external tab 376 that can be connected (e.g., via welding) to an external circuit, such as the common positive electrical conductor 396 that is in electrical communication with the external load device 390 and common negative electrical conductor 394.

In FIG. 5A, a plurality of the first bipolar electrodes 320, namely three distinct first bipolar electrodes, 320A, 320B, 320C are disposed between the dual-sided monopolar positive electrode 290 and the dual-sided monopolar negative electrode 300. The first bipolar electrodes, 320A, 320B, 320C are oriented such that the first side 321 of the bipolar electrode 320A (having a negative polarity) faces the dual-sided monopolar positive electrode 290. Likewise, the second side 323 of the bipolar electrodes 320 (having a positive polarity) faces the dual-sided monopolar negative electrode 300. The positive electroactive material 328 on the second side 323 of the first bipolar electrode 320A faces the negative electroactive material 326 on the first side 321 of first bipolar electrode 320B. Further, the positive electroactive material 328 on the second side 323 of first bipolar electrode 320B faces the negative electroactive material 326 on the first side 321 of first bipolar electrode 320C. Thus, first bipolar electrodes, 320A, 320B, 320C form interlayers with appropriate polarity between the dual-sided monopolar positive electrode 290 and the dual-sided monopolar negative electrode 300.

The first negative current collector 362 of the terminal negative electrode 360 defines or is in contact with the first negative external tab 366 that can be connected (e.g., via welding) to a common negative electrical conductor 394 that is in electrical communication with the interruptible external circuit 392. The interruptible circuit 392 also includes the load device 390 and the common positive electrical conductor 396 that is in direct electrical communication with select positive electrodes in the battery 350.

Again, each of first bipolar electrodes 320A, 320B, 320C is free of any tabs or connection to external conductors or circuits. Thus, neither the positive current collector 324 nor the negative current collector 322 of each of first bipolar electrodes 320A, 320B, 320C defines or is connected to any protruding external tabs or terminals. Thus, first bipolar electrodes 320A, 320B, 320C are incorporated into a battery 350 stack so that each bipolar electrode is electrically connected in series with adjacent electrodes to increase voltage, but is not directly connected by wiring or terminals to an external circuit.

However, the second positive external tab 296 of the dual-sided monopolar positive electrode 290 is in direct electrical contact with the common positive conductor 396 and the second negative external tab 306 of the dual-sided monopolar negative electrode 300 is in direct electrical contact with the common negative conductor 394. Thus, the dual-sided monopolar positive electrode 290 and the dual-sided monopolar negative electrode 300 are in direct electrical communication with external circuit 392.

A plurality of second bipolar electrodes, namely three second bipolar electrodes 330A, 330B, and 330C are disposed between the terminal negative electrode 360 and the dual-sided monopolar positive electrode 290. The second bipolar electrodes 330A, 330B, 330C are oriented such that a first side 331 of the bipolar electrode 330A (having a positive polarity) faces the terminal negative electrode 360. Likewise, a second side 333 of the bipolar electrode 330C (having a negative polarity) faces the dual-sided monopolar positive electrode 290. The negative electroactive material 338 on the second side 333 of the second bipolar electrode 330A faces the positive electroactive material 336 on the first side 331 of second bipolar electrode 330B. Further, the negative electroactive material 338 on the second side 333 of second bipolar electrode 330B faces the positive electroactive material 336 on the first side 331 of second bipolar electrode 330C. Thus, second bipolar electrodes 330A, 330B, 330C form interlayers with appropriate polarity between the terminal negative electrode 360 and the dual-sided monopolar positive electrode 290.

Again, each of second bipolar electrodes 330A, 330B, 330C is free of any tabs or connection to external conductors or circuits. Thus, neither the positive current collector 332 nor the negative current collector 334 of each of second bipolar electrodes 330A, 330B, 330C defines or is connected to any protruding external tabs or terminals. Thus, second bipolar electrodes 330A, 330B, 330C are incorporated into a battery 350 stack so that each bipolar electrode is electrically connected in series with adjacent electrodes to increase voltage, but is not directly connected by wiring or terminals to an external circuit.

Another plurality of second bipolar electrodes, namely three second bipolar electrodes 330D, 330E, and 330F are disposed between the dual-sided monopolar negative electrode 300 and the terminal positive electrode 370. The second bipolar electrodes 330D, 330E, and 330F are oriented such that the first side 331 of the bipolar electrode 330D (having a positive polarity) faces the dual-sided monopolar negative electrode 300. Likewise, the second side 333 of the bipolar electrode 330F (having a negative polarity) faces the terminal positive electrode 370. The negative electroactive material 338 on the second side 333 of the second bipolar electrode 330D faces the positive electroactive material 336 on the first side 331 of second bipolar electrode 330E. Further, the negative electroactive material 338 on the second side 333 of second bipolar electrode 330E faces the positive electroactive material 336 on the first side 331 of second bipolar electrode 330F. Thus, second bipolar electrodes, 330D, 330E, 330F form interlayers with appropriate polarity between the dual-sided monopolar negative electrode 300 and terminal negative electrode 370.

Again, each of second bipolar electrodes 330D, 330E, 330F is free of any tabs or connection to external conductors or circuits. Thus, neither the positive current collector 332 nor the second negative current collector 334 of each of second bipolar electrodes 330D, 330E, and 330F defines or is connected to any protruding external tabs or terminals. Thus, second bipolar electrodes 330D, 330E, and 330F are incorporated into a battery 350 stack so that each bipolar electrode is electrically connected in series with adjacent electrodes to increase voltage, but is not directly connected by wiring or terminals to an external circuit.

In this manner, a plurality of battery unit cells 380 are defined between each electrode of an opposite polarity within battery 350, whether considering the electrodes of opposite polarity to be defined by an electrode in a bipolar interlayer electrode, a monopolar dual-sided electrode, or a terminal electrode.

As will be appreciated by those of skill in the art, each of the first or second bipolar electrodes (320A, 320B, 320C, 330A, 330B, 330C, 330D, 330E, and 330F) creates a serial electrical connection with an adjacent electrode of a bipolar electrode and one of: terminal negative electrode 360, dual-sided monopolar positive electrode 290, dual-sided monopolar negative electrode 300, or terminal positive electrode 370. However, the terminal negative electrode 360, dual-sided monopolar positive electrode 290, dual-sided monopolar negative electrode 300, and terminal positive electrode 370 are directly connected externally via the common positive electrical conductor 396 and the common negative electrical conductor 394 in a parallel electrical configuration (to external circuit 392). Thus, this battery design also includes a new electrode-overlaying configuration that combines both parallel and serial connection between electrodes in a battery cell. The dimensions or footprint of the battery 350 remains the same. However, the presence of the battery cells/internal units connected in parallel provide higher current output, while the series cells provide elevated cell voltage.

FIG. 5B shows a representative circuit diagram of the battery 350 stack in FIG. 5A where the battery unit cells have both electrical connections in parallel and in series. In FIG. 5B, the four distinct unit cells 380 are each represented by power source symbols 400. Thus, the interlayers of bipolar electrodes introduce serially electrically connected power sources 400 as shown in each respective columns 402. There are four power sources 400 in each column 402. Further, power sources 400 are electrically connected in parallel with one another as shown at rows 404 corresponding to each monopolar or terminal electrode (360, 370, 290, or 300) connected in parallel with the external circuit. As appreciated by those of skill in the art, the battery 350 may include additional components that create additional power sources 400/battery unit cells 380 in such a stack. The overall effect of having a plurality of unit cells electrically connected in parallel is to increase current density of the stack, while select unit cells being configured to be in parallel and electrically connected internally within the stack increases an overall voltage of the stack.

For example, because of the presence of the four bipolar electrode interlayers, the voltage can thus be quadrupled. For common Li—S chemistry, the average cell voltage is 2.1V, so by the design shown in battery 350, a voltage (V) will be 8.4 V (where 2.1V+2.1V+2.1V+2.1V=8.4V). It should be noted that there is no limit on the number of bipolar electrodes that may be incorporated into a stack (e.g., between monopolar and/or terminal electrodes) and that the designs shown are merely non-limiting examples.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery that cycles lithium ions comprising:
at least one first monopolar electrode having a first polarity and comprising a first electroactive material that reversibly cycles lithium ions disposed on two sides of a first current collector in electrical communication with a first tab;
at least one second monopolar electrode having a second polarity opposite to the first polarity and comprising a second electroactive material that reversibly cycles lithium ions and that is distinct from the first electroactive material disposed on two sides of a second current collector in electrical communication with a second tab, wherein the first tab and the second tab are in electrical communication with an external circuit; and
at least one bipolar electrode disposed between and electrically insulated from the first monopolar electrode and the second monopolar electrode, wherein a first side of the bipolar electrode has the first polarity and comprises a third electroactive material that reversibly cycles lithium ions disposed on a third current collector and a second side of the bipolar electrode has the second polarity and comprises a fourth electroactive material that reversibly cycles lithium ions and disposed on a fourth current collector, wherein the third and fourth current collectors are adjacent to one another and free of any tabs or external electrical connectors, wherein the battery comprises at least one first unit cell connected in parallel and at least one second unit cell connected in series.

2. The battery of claim 1, further comprising a plurality of first monopolar electrodes, a plurality of second monopolar electrodes, and a plurality of bipolar electrodes, wherein the first tabs of each of the plurality of first monopolar electrodes are connected in parallel with one another and the second tabs of each of the plurality of second monopolar electrodes are connected in parallel with one another.

3. The battery of claim 1, wherein the first electroactive material and the third electroactive material are the same.

4. The battery of claim 1, wherein the second electroactive material and the fourth electroactive material are the same.

5. The battery of claim 1, wherein the first electroactive material and the third electroactive material are independently selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), S, S₈, Li₂S₈, Li₂S₆, Li₂S₄, Li₂S₂, Li₂S and combinations thereof.

6. The battery of claim 1, wherein the second electroactive material and the fourth electroactive material are independently selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

7. The battery of claim 1, further comprising a first separator disposed between the at least one bipolar electrode and the first monopolar electrode and a second separator disposed between the at least one bipolar electrode and the second monopolar electrode.

8. The battery of claim 7, further comprising a first electrolyte in fluid communication with the first separator and the first side of the bipolar electrode and a second electrolyte in fluid communication with the second separator and the second side of the bipolar electrode, wherein the first electrolyte and the second electrolyte are isolated from one another.

9. The battery of claim 1, further comprising a first solid-state electrolyte layer disposed between the at least one bipolar electrode and the first monopolar electrode and a second solid-state electrolyte layer disposed between the at least one bipolar electrode and the second monopolar electrode.

10. The battery of claim 1, wherein a maximum difference in voltage between the first electroactive material and the fourth electroactive material or between the second electroactive material and the third electroactive material is less than or equal to about 2.4V.

11. A battery that cycles lithium ions comprising:
at least one first monopolar electrode having a first polarity and comprising a first electroactive material that reversibly cycles lithium ions disposed on two sides of a first current collector in electrical communication with a first tab;
at least one second monopolar electrode having a second polarity opposite to the first polarity and comprising a second electroactive material that reversibly cycles lithium ions and that is distinct from the first electroactive material disposed on two sides of a second current collector in electrical communication with a second tab, wherein the first tab and the second tab are in electrical communication with an external circuit; and
a plurality of bipolar electrodes disposed between and electrically insulated from the first monopolar electrode and the second monopolar electrode, wherein each bipolar electrode of the plurality of bipolar electrodes defines a first side having the first polarity and comprising a third electroactive material that reversibly cycles lithium ions disposed on a third current collector and a second side of the bipolar electrode having the second polarity and comprising a fourth electroactive material that reversibly cycles lithium ions and disposed on a fourth current collector, wherein the third and fourth current collectors are adjacent to one another and free of any tabs or external electrical connectors, and the battery comprises at least one first unit cell connected in parallel and a plurality of second unit cells connected in series.

12. The battery of claim 11, further comprising a plurality of first monopolar electrodes and a plurality of second monopolar electrodes, wherein the first tabs of each of the plurality of first monopolar electrodes are connected in parallel with one another and the second tabs of each of the plurality of second monopolar electrodes are connected in parallel with one another.

13. The battery of claim 11, wherein the first electroactive material and the third electroactive material are the same and the second electroactive material and the fourth electroactive material are the same.

14. The battery of claim 11, wherein the first electroactive material and the third electroactive material are independently selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof.

15. The battery of claim 11, wherein the second electroactive material and the fourth electroactive material are independently selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

16. The battery of claim 11, further comprising a solid-state electrolyte disposed between each bipolar electrode of the plurality of bipolar electrodes.

17. The battery of claim 11, further comprising a separator disposed between each bipolar electrode of the plurality of bipolar electrodes and an electrolyte that is isolated from adjacent cells defined by the plurality of bipolar electrodes.

18. The battery of claim 11, wherein the plurality of bipolar electrodes defines a first terminal bipolar electrode at a first end and a second terminal bipolar electrode at a second end and the lithium-ion battery further comprises a first separator disposed between the first terminal bipolar electrode and the first monopolar electrode and a second separator disposed between the second terminal bipolar electrode and the second monopolar electrode.

19. The battery of claim 11, wherein the plurality of bipolar electrodes comprise at least two bipolar electrodes disposed between the at least one first monopolar electrode and the at least one second monopolar electrode.

20. The battery of claim 11, wherein a maximum difference in voltage between the first electroactive material and the fourth electroactive material or between the second electroactive material and the third electroactive material is less than or equal to about 2.4V.
